(19) United States
(12) Patent Application Publication
(10) Pub. No.: US 2003/0011086 A1
(43) Pub. Date: Jan. 16, 2003

(54) Vapor cleaner

(76) Inventor: Lambert Wu, Taipei Hsien (TW)

Correspondence Address: RABIN & CHAMPAGNE, PC, 1101 14TH STREET, NW, SUITE 500, WASHINGTON, DC, 20005, US

(21) Appl. No.: 09/904,664

(22) Filed: Jul. 16, 2001

(51) Int. Cl. B01F 3/04

(52) U.S. Cl. 261/119.1; 261/142; 261/DIG. 65

(57) ABSTRACT

A vapor cleaner comprises a main body, a water tank, an electric heater and a pressure valve. The pressure valve is composed of a baffle plate, a nozzle, a piston and a spring. The provision of the pressure valve can retard the instant ejection of vapor until the vapor pressure reaches a predetermined value. Therefore, the vapor can be smoothly sprayed with larger pressure and temperature. The droplet is smaller and the vaporization is uniformly generated.

### FIELD OF THE INVENTION

The present invention relates to a vapor cleaner, especially to a vapor cleaner producing vapor with larger pressure and temperature, and droplet with smaller size, and uniform vaporization.

### BACKGROUND OF THE INVENTION

FIG. 1 shows a prior art vapor cleaner, which mainly comprises a main body 10a, a water tank 11a within the main body 10a, a water inlet 12a for injecting water into the water tank 11a, and an electric heater 13a on bottom of the water tank 11a to heat the water in the water tank 11a into vapor. The vapor is sprayed from a nozzle 14a on topside of the water tank 11a. The nozzle 14a is also connected to a vapor conduit and a brush (not shown), through which the vapor is sprayed outside for sterilization.

The vapor cleaner further comprises a leakage valve 15a atop the water inlet 12a to prevent over pressure of vapor in the water tank 11a.

However, the vapor pressure may not be uniform as being sprayed from the nozzle 14a. As a result, droplet may be present in the vapor.

### SUMMARY OF THE INVENTION

It is the first object of the present invention to provide a vapor cleaner with a pressure valve, which can retard the instant ejection of vapor until the vapor pressure reaches a predetermined value. Therefore, the vapor can be smoothly sprayed with larger pressure and temperature. The droplet is smaller and the vaporization is uniformly generated.

To achieve the object, the present invention provides a vapor cleaner comprising a vapor cleaner with a main body, a water tank, an electric heater and a pressure valve. The main body is of hollow shape and the water tank is arranged within the main body. The water tank has a water inlet and an air outlet. The electric heater is arranged on bottom of the water tank and the pressure valve is arranged at the air outlet.

The various objects and advantages of the present invention will be more readily understood from the following detailed description when read in conjunction with the appended drawing, in which:

### BRIEF DESCRIPTION OF DRAWINGS

FIG. 1 shows the sectional view of prior art vapor cleaner;

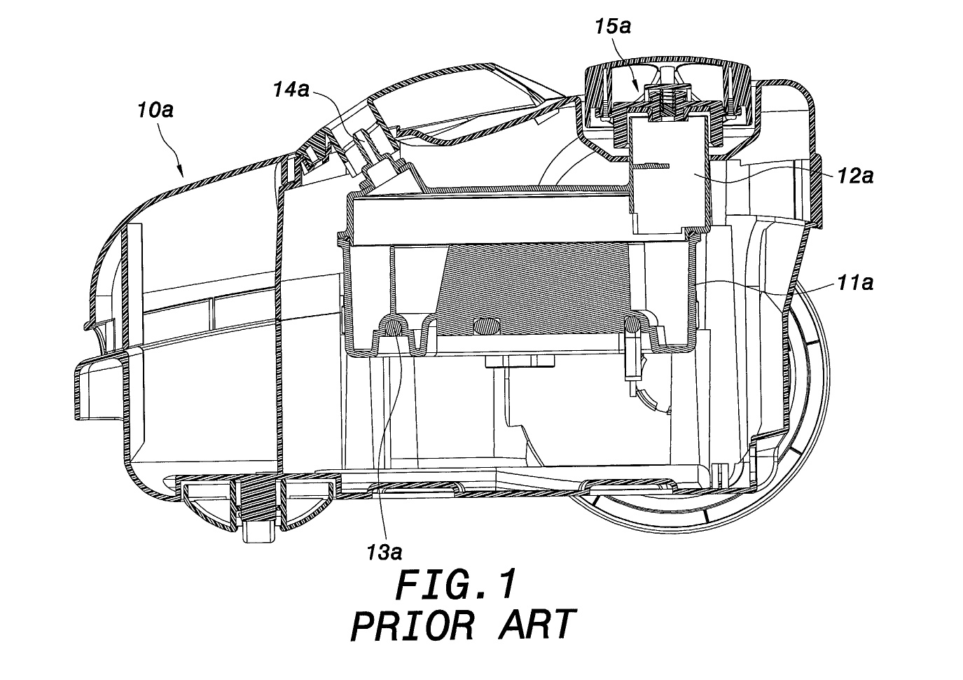

FIG. 2 is a perspective view of the present invention;

FIG. 3 shows the exploded view of the present invention;

FIG. 4 shows the sectional view of the present invention;

FIG. 5 shows the exploded view of the pressure valve of the present invention; and

FIG. 6 shows the exploded view of the leakage valve of the present invention.

### DETAILED DESCRIPTION OF THE INVENTION

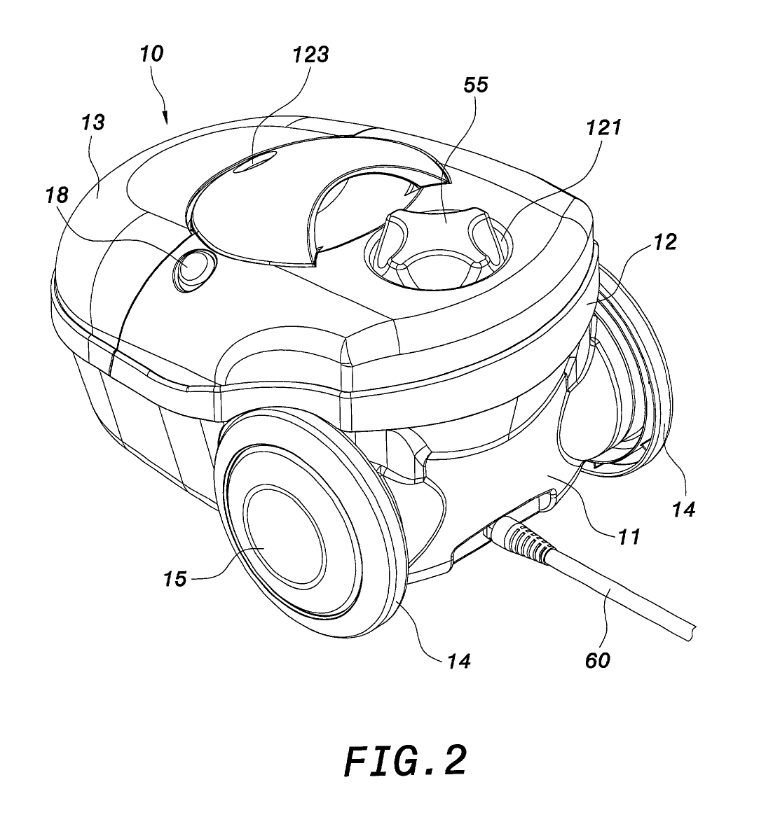

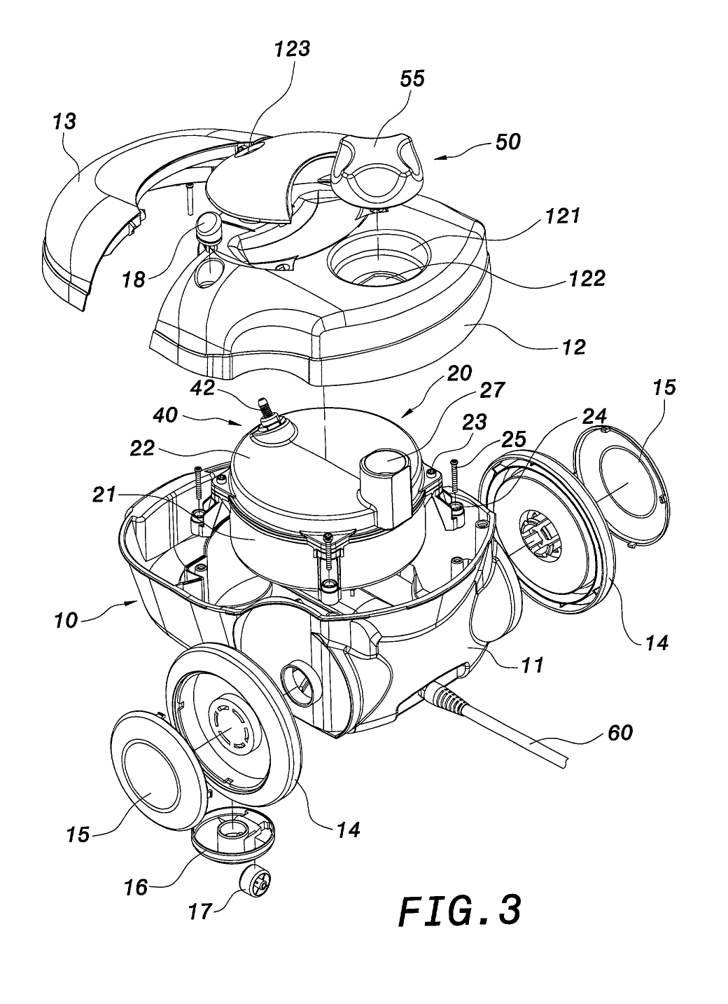

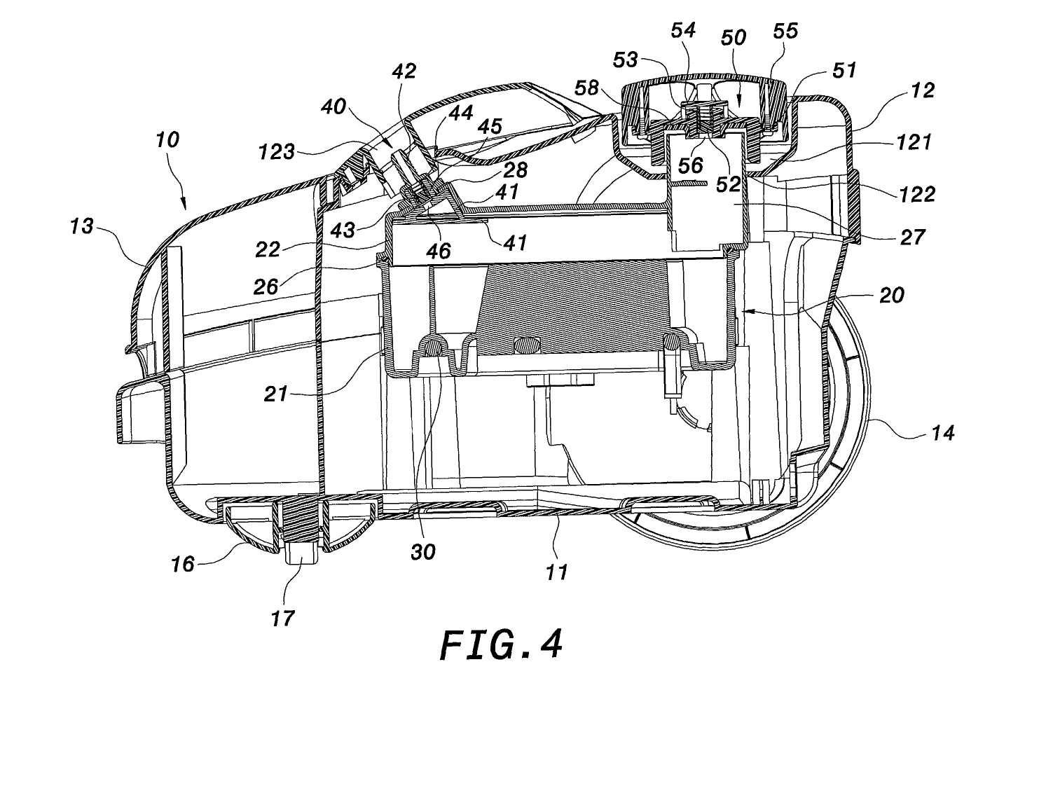

With reference now to FIGS. 2 to 4, the present invention is intended to provide a vapor cleaner, which comprises a main body 10, a water tank 20, an electric heater 30, a pressure valve 40 and a leakage valve 50. The main body 10 has a base 11, a top lid 12 and an unfolding cover 13. The base 11 is a hollow shell with opened top portion and the top lid 12 and the unfolding cover 13 are assembled on the opened top portion of the base 11 to form an integral hollow shell.

The base 11 has two rear wheels 14 on two lateral sides thereof and each rear wheel 14 has a wheel cover 15 to provide integral appearance. The base 11 has a front wheel 16 pivotally arranged at front side thereof and the front wheel 16 has an auxiliary wheel 17 pivotally arranged thereto. The provision of the rear wheels 14, the front wheel 16 and the auxiliary wheel 17 facilitate the movement of the vapor cleaner.

The vapor cleaner has a power switch 18 on the top lid 12 to turn on/off the electric heater 30. The top lid 12 contains a leakage valve tank 121 with a through hole 122 on bottom thereof and a pressure valve tank 123 with an opened bottom.

The water tank 20 is arranged within the main body 10 and is composed of an upper cover 22 and a lower cover 21 assembled integrally through screws 23. The water tank 20 is fixed to the main body 10 by fixing member 24 and screw 25. Moreover, a silicone rubber band 26 is provided between the upper cover 22 and the lower cover 21 to seal the water tank 20.

The upper cover 22 has a tubular water inlet 27 communicated with the leakage valve tank 121 through the through hole 122. The upper cover 22 further has an air outlet 28 corresponding to the pressure valve tank 123.

The electric heater 30 is an electrothermic pipe arranged on bottom of the lower cover 21 and acquiring power through a power cord 60. The electric heater 30 heats the water in the tank 20 to generate vapor and is turned on/off by the power switch 18.

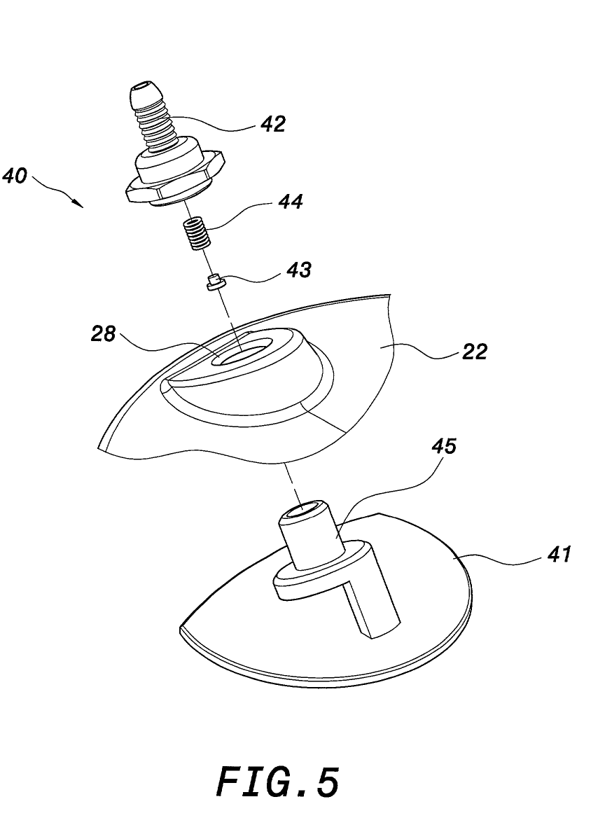

The pressure valve 40 is arranged on the air outlet 28 and within the pressure valve tank 123. The pressure valve 40 is composed of a baffle plate 41, a nozzle 42, a piston 43 and a spring 44 as shown in FIG. 5. The baffle plate 41 is arranged below the air outlet 28 and has a conduit 45 atop it. The conduit 45 extends upward through the air outlet 28 and out of the topside of the water tank 20. The baffle plate 41 is used to prevent the droplet from directly spraying from the nozzle when the pressure valve 40 is opened, whereby the vapor can be more uniformly atomized.

The nozzle 42 is of hollow shape and connected to the conduit 45 atop the water tank 20. The nozzle 42 extends into the pressure valve tank 123, and the piston 43 and the spring 44 are fit into the conduit 45. The conduit 45 has a vent hole 46, which is elastically closed or opened by the piston 43 driven by the spring 43.

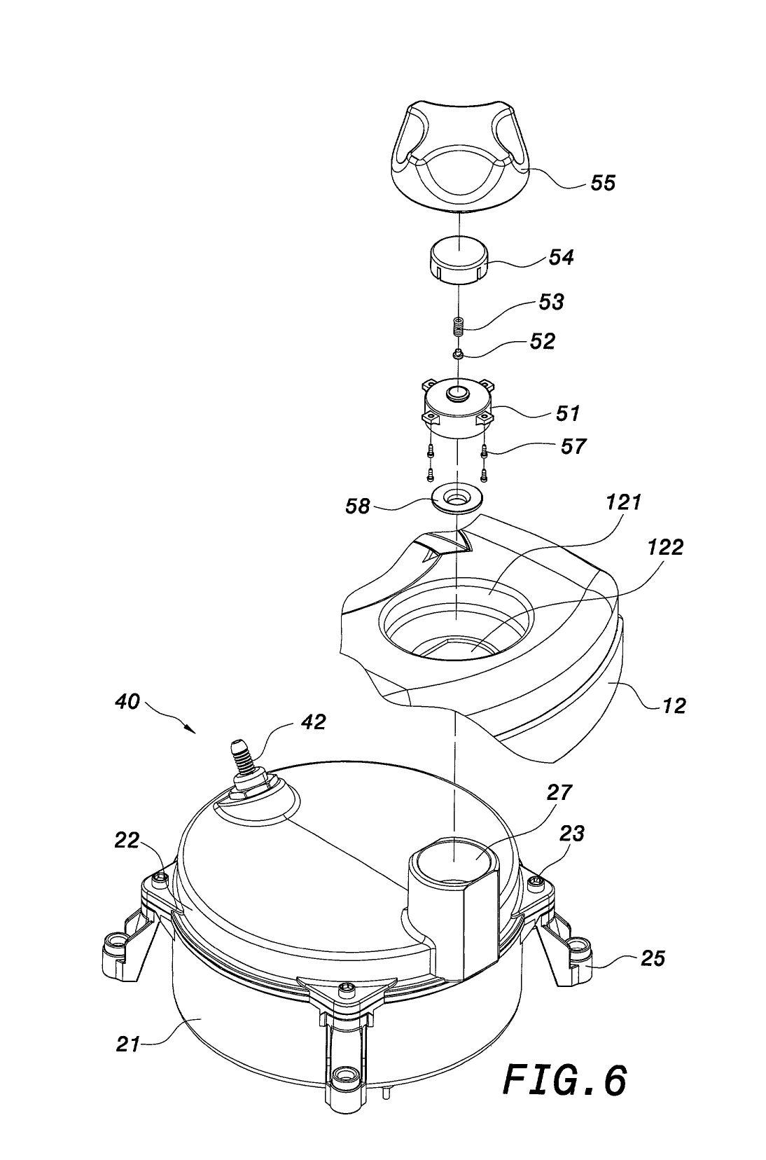

The leakage valve 50 is arranged in the tubular water inlet 27 and within the leakage valve tank 121. The leakage valve 50 is composed of an inner cover 51, a piston 52, a spring 53, a locking member 54 and an outer cover 55 as shown in FIG. 6. The inner cover 51 is of hollow shape and arranged atop the water inlet 27. The inner cover 51 and has a leakage through hole 56.

The piston 52 and the spring 53 are fit in the inner cover 51, and the leakage through hole 56 is elastically closed or opened by the piston 52 driven by the spring 53.

The locking member 54 is locked atop the inner cover 51 and used to lock the piston 52 and the spring 53. The outer cover 55 is arranged atop the locking member 54. The inner cover 51 and the outer cover 55 are assembled together by screw 57. The inner cover 51 is sealed by silicone rubber 58 on inner side thereof.

The water tank 20 is injected water through the water inlet 27 and the injected water is heated by the electric heater 30 and become vaporization. Initially, the piston 43 is pressed by the spring 44 to seal the vent hole 46, whereby the vapor is not emitted from the pressure valve 40 at this stage. When the vapor pressure reaches a predetermined value, the vapor presses the piston 43 through the vent hole 46 and the spring 44 is compressed. The vent hole 46 is opened and the vapor is sprayed through the conduit 45, the nozzle 42. The nozzle is connected to a vapor conduit and a brush (not shown), through which the vapor is sprayed outside for sterilization.

The operating pressure setting of the leakage valve 50 is larger than the operating pressure setting of the pressure valve 40. At normal operation, the vapor is not sprayed through the leakage valve 50. However, if the vapor pressure in the water tank 20 exceeds a predetermined value due to slow rate of vapor emission from the pressure valve 40, the vapor presses the piston 52 through the leakage through hole 56. The piston 52 compresses the spring 53 to open the leakage through hole 56. The over-pressure vapor can be leaked through the inner cover 51 to enhance safety.

To sum up, in the present invention, the provision of the pressure valve 40 can retard the instant ejection of vapor until the vapor pressure reaches a predetermined value. Therefore, the vapor can be smoothly sprayed with larger pressure and temperature. The droplet is smaller and the vaporization is uniformly generated.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A vapor cleaner comprising
a main body;
a water tank arranged within the main body and having an air outlet;
an electric heater arranged on bottom of the water tank; and
a pressure valve composed of a baffle plate, a nozzle, a piston and a spring; the baffle plate arranged below the air outlet and having a conduit atop it, the conduit extending upward through the air outlet and out of the topside of the water tank, the nozzle connected to the conduit, the piston and the spring fit into the conduit, the conduit having a vent hole, which is elastically closed or opened by the piston driven by the spring.

2. The vapor cleaner as in claim 1, wherein the main body has a base, a top lid and an unfolding cover, the top lid and the unfolding cover assembled on a top portion of the base.

3. The vapor cleaner as in claim 1, wherein the base has two rear wheels pivotally arranged on two lateral sides thereof, a front wheel pivotally arranged at front side thereof, and the front wheel having an auxiliary wheel pivotally arranged thereto.

4. The vapor cleaner as in claim 1, wherein the water tank is arranged within the main body and is composed of an upper cover and a lower cover assembled integrally through screws, the water tank fixed to the main body by a fixing member and screw, a silicone rubber band provided between the upper cover and the lower cover to seal the water tank.
